(19) United States
(12) Patent Application Publication
(10) Pub. No.: US 2021/0310565 A1
(43) Pub. Date: Oct. 7, 2021

(54) VALVE DEVICE

(71) Applicant: NIDEC TOSOK CORPORATION, Kanagawa (JP)

(72) Inventors: Tomohiko NAKANISHI, Kanagawa (JP); Yuji TAKADA, Kanagawa (JP); Hiroki SHIMIZU, Kanagawa (JP); Naoki TAMURA, Kanagawa (JP)

(73) Assignee: NIDEC TOSOK CORPORATION, Kanagawa (JP)

(21) Appl. No.: 17/216,646

(22) Filed: Mar. 29, 2021

(30) Foreign Application Priority Data
Apr. 1, 2020 (JP) 2020-066001

(51) Int. Cl. F16K 1/42; F16K 31/06; F16K 39/02

(52) U.S. Cl. CPC F16K 1/42; F16K 39/02; F16K 31/0655

(57) ABSTRACT

A valve device includes a flow channel member having a first flow channel, an electromagnetic valve having a movable piece movable in a predetermined direction and being capable of opening and closing the first flow channel, and a valve seat body fixed to the first flow channel. The first flow channel has a first flow channel main body and an opening connected to one end of the first flow channel main body with a step therebetween. The valve seat body has a fixed part fitted into an inside of the opening, an extension which extends from the fixed part, a circulation hole which penetrates the fixed part and the extension, and a valve seat which is provided at an end of the circulation hole. The movable piece has a valve body which is able to be seated in the valve seat from one side in the predetermined direction.

### CROSS REFERENCE TO RELATED APPLICATIONS

The present invention claims priority under 35 U.S.C. § 119 to Japanese Application No. 2020-066001 filed on Apr. 1, 2020 the entire content of which is incorporated herein by reference.

### BACKGROUND

### Field of the Invention

The disclosure relates to a valve device.

### Background

Valve devices including a flow channel member that has a flow channel and an electromagnetic valve that is capable of opening and closing the flow channel are known.

In the valve device described above, for example, the flow channel is opened and closed by switching between a state in which a valve body of the electromagnetic valve is seated in a valve seat provided in the flow channel and a state in which the valve body is separated from the valve seat. However, when the valve body is seated in the valve seat, there is concern that sealing properties between the valve body and the valve seat may be insufficient and the flow channel may not be able to be sufficiently closed.

### SUMMARY

An exemplary embodiment of the disclosure provides a valve device including a flow channel member that has a first flow channel, an electromagnetic valve that has a movable piece capable of moving in a predetermined direction and is capable of opening and closing the first flow channel, and a valve seat body that is fixed to the first flow channel. The first flow channel has a first flow channel main body, and an opening which has an inner diameter larger than an inner diameter of the first flow channel main body and is connected to one end of the first flow channel main body with a step therebetween. The opening opens to one side in the predetermined direction. The valve seat body has a fixed part which is fixed by being fitted into an inside of the opening and is supported by the step from the other side in the predetermined direction, an extension which extends from the fixed part to the other side in the predetermined direction and is inserted into the first flow channel main body, a circulation hole which penetrates the fixed part and the extension in the predetermined direction, and a valve seat which is provided at an end of the circulation hole on one side in the predetermined direction. The movable piece has a valve body which is able to be seated in the valve seat from one side in the predetermined direction. The circulation hole has a first circulator which opens to one side in the predetermined direction and is provided in the valve seat, and a second circulator at least a portion of which is provided in the extension. An inner diameter of the first circulator is larger than an inner diameter of the second circulator.

The above and other elements, features, steps, characteristics and advantages of the present disclosure will become more apparent from the following detailed description of the preferred embodiments with reference to the attached drawings.

### BRIEF DESCRIPTION OF THE DRAWINGS

FIG. 1 is a cross-sectional view illustrating a valve device according to an exemplary embodiment of the present disclosure and is a view illustrating an open state in which a first flow channel is open.

FIG. 2 is a cross-sectional view illustrating a valve device according to an exemplary embodiment of the present disclosure and is a view illustrating a closed state in which the first flow channel is closed.

FIG. 3 is a cross-sectional view illustrating a valve seat body according to an exemplary embodiment of the present disclosure.

### DETAILED DESCRIPTION

In the following description, a direction parallel to a Z axis suitably illustrated in each diagram will be referred to as a vertical direction. A positive side of the Z axis will be referred to as an upper side, and a negative side of the Z axis will be referred to as a lower side. A center axis J which is an imaginary axis suitably illustrated in each diagram extends in a Z axis direction, that is, a direction parallel to the vertical direction. In the following description, a direction parallel to an axial direction of the center axis J will be simply referred to as “an axial direction”. In addition, unless otherwise specified, a radial direction centering on the center axis J will be simply referred to as “a radial direction”, and a circumferential direction centering on the center axis J will be simply referred to as “a circumferential direction”.

In this exemplary embodiment, the axial direction corresponds to “a predetermined direction”. The upper side corresponds to “one side in the predetermined direction”, and the lower side corresponds to “the other side in the predetermined direction”. The vertical direction, the upper side, and the lower side are names for simply describing relative positional relationships between parts, and actual disposition relationships and the like may be disposition relationships and the like other than the disposition relationships and the like indicated by these names.

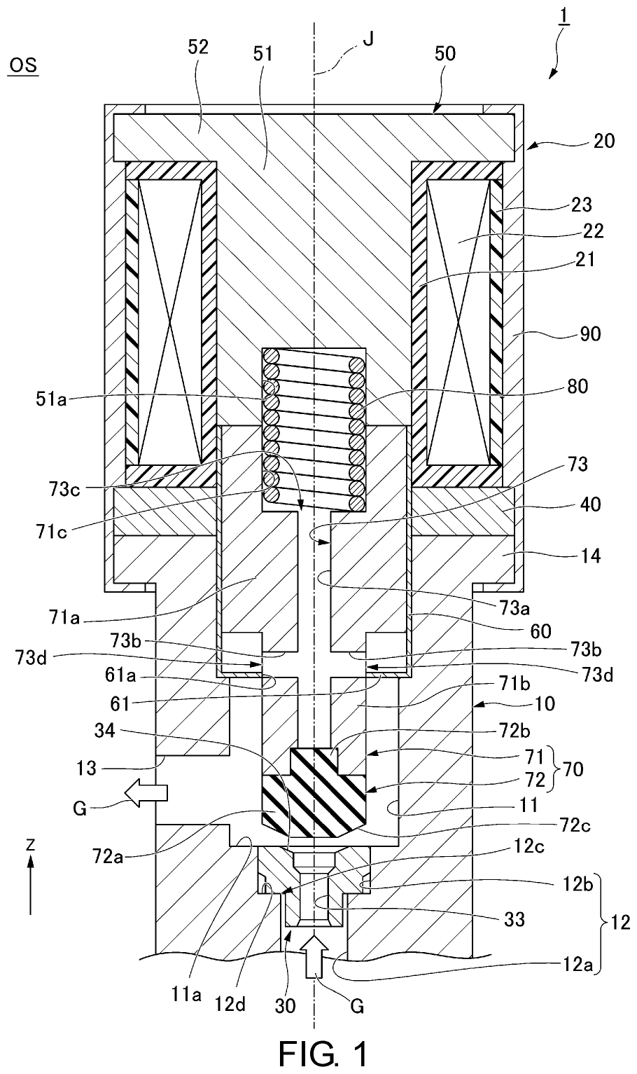

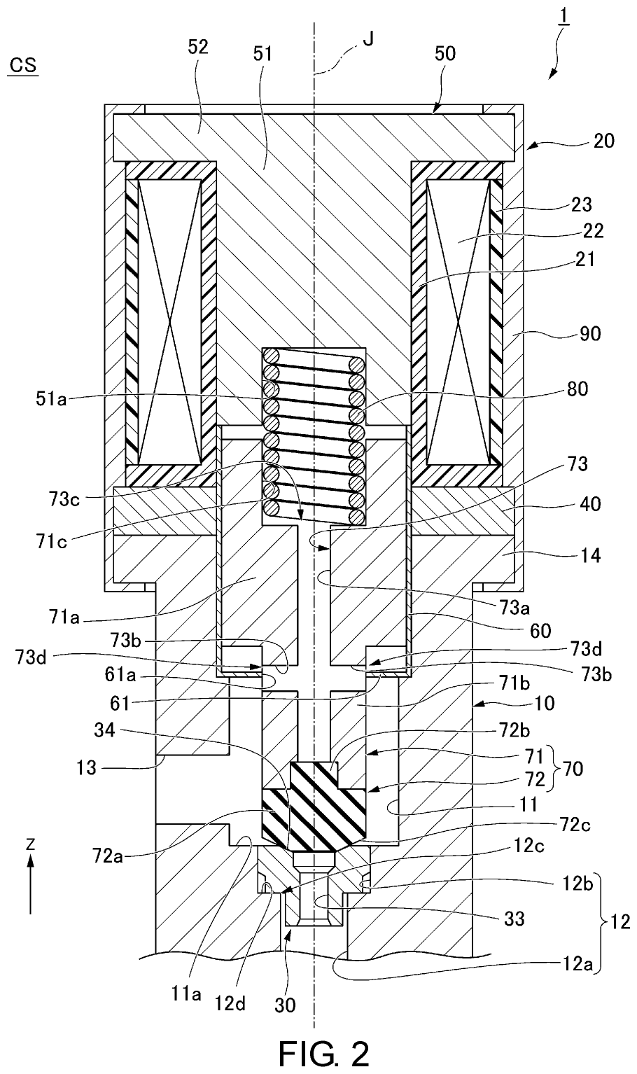

A valve device 1 of this exemplary embodiment illustrated in FIGS. 1 and 2 is mounted in a vehicle. For example, the valve device 1 is a positive crankcase ventilation valve (PCV valve). As illustrated in FIGS. 1 and 2, the valve device 1 of the exemplary embodiment includes a flow channel member 10, an electromagnetic valve 20, and a valve seat body 30. In the exemplary embodiment, the flow channel member 10 is made of metal. For example, a material constituting the flow channel member 10 is aluminum. The flow channel member 10 may be made of resin.

The flow channel member 10 has a valve chamber 11, a first flow channel 12, a second flow channel 13, and a flange 14. A valve body 72 (which will be described below) is inserted into the valve chamber 11. In this exemplary embodiment, the valve chamber 11 is defined by blocking an opening of a hole on the upper side recessed from an end of the flow channel member 10 on the upper side to the lower side by the electromagnetic valve 20.

In this exemplary embodiment, the first flow channel 12 is a flow channel through which a fluid flowing into the valve chamber 11 passes. In other words, in this exemplary embodiment, the first flow channel 12 is an inlet port. In this exemplary embodiment, the fluid is a gas G. For example, the gas G is blow-by gas. For example, the first flow channel 12 extends in the axial direction. For example, a flow channel cross-sectional shape of the first flow channel 12 has a substantially circular shape centering on the center axis J. The first flow channel 12 has a first flow channel main body 12a and an opening 12b. The first flow channel main body 12a is a portion of the first flow channel 12 excluding the opening 12b.

The opening 12b is one end of the first flow channel 12. The opening 12b opens to the upper side. The opening 12b opens to the inside of the valve chamber 11. More specifically, the opening 12b opens to a bottom surface 11a on an inner surface of the valve chamber 11 on the lower side. Accordingly, the first flow channel 12 is connected to the valve chamber 11 via the opening 12b. For example, the bottom surface 11a is a substantially flat surface orthogonal to the axial direction.

An inner diameter of the opening 12b is larger than an inner diameter of the first flow channel main body 12a. The opening 12b is connected to one end of the first flow channel main body 12a with a step 12c therebetween. More specifically, the opening 12b is connected to an end of the first flow channel main body 12a on the upper side with the step 12c therebetween. The step 12c is a step recessed outward in the radial direction when an inner circumferential surface of the first flow channel 12 is followed from an inner circumferential surface of the first flow channel main body 12a to an inner circumferential surface of the opening 12b. The step 12c has a step surface 12d directed to the upper side. For example, the step surface 12d is a substantially flat surface having a substantially circular annular shape centering on the center axis J.

In this exemplary embodiment, the second flow channel 13 is a flow channel through which the gas G that has flowed into the valve chamber 11 via the first flow channel 12 flows out. In other words, in this exemplary embodiment, the second flow channel 13 is an outlet port. For example, the second flow channel 13 extends in a direction orthogonal to the axial direction. For example, the second flow channel 13 extends in a lateral direction in FIGS. 1 and 2. For example, the second flow channel 13 has a substantially circular flow channel cross-sectional shape. The second flow channel 13 is connected to the valve chamber 11. For example, in the second flow channel 13, an end on the right side is connected to the valve chamber 11 in FIGS. 1 and 2.

The flange 14 is provided at the end of the flow channel member 10 on the upper side. The flange 14 protrudes outward in the radial direction. For example, the flange 14 has a substantially circular annular shape centering on the center axis J.

The electromagnetic valve 20 has a bobbin 21, a coil 22, a resin member 23, an annular member 40, a core 50, a guiding tube 60, a movable piece 70, an elastic member 80, and an accommodation case 90. The bobbin 21 has a substantially tubular shape surrounding the center axis J. For example, the bobbin 21 has a substantially cylindrical shape centering on the center axis J and opening to both sides in the axial direction. The coil 22 is wound around the bobbin 21. In this exemplary embodiment, the bobbin 21 is made of resin. The coil 22 is wound around the center axis J extending in the axial direction. In this exemplary embodiment, the coil 22 is wound around an outer circumferential surface of the bobbin 21. The resin member 23 covers the coil 22 from a side outward in the radial direction.

The annular member 40 is made of a magnetic material. The annular member 40 has a substantially annular shape surrounding the center axis J. For example, the annular member 40 has a substantially circular annular shape centering on the center axis J. For example, an inner circumferential surface of the annular member 40 is located at the same position as an inner circumferential surface of the bobbin 21 in the radial direction. For example, an outer circumferential surface of the annular member 40 is located at the same position as an outer circumferential surface of the flange 14 in the radial direction. The annular member 40 is located on the lower side of the bobbin 21. The annular member 40 is located on the upper side of the flange 14. The annular member 40 is interposed between the bobbin 21 and the flange 14 in the axial direction.

The core 50 is made of a magnetic material. The core 50 has a core main body 51 and a core flange 52. The core main body 51 has a substantially pillar shape extending in the axial direction. For example, the core main body 51 has a substantially columnar shape centering on the center axis J. The core main body 51 is inserted into an inward side of the bobbin 21 in the radial direction from the upper side. In this exemplary embodiment, the core main body 51 is fitted into the inward side of the bobbin 21 in the radial direction. The core main body 51 has a holding recess 51a recessed from a surface of the core main body 51 on the lower side to the upper side. For example, the holding recess 51a has a substantially circular shape centering on the center axis J when viewed in the axial direction.

The core flange 52 protrudes outward in the radial direction from an end of the core main body 51 on the upper side. For example, the core flange 52 has a substantially circular annular shape centering on the center axis J. For example, an outer circumferential surface of the core flange 52 is located at the same position as the outer circumferential surface of the flange 14 and the outer circumferential surface of the annular member 40 in the radial direction. The core flange 52 comes into contact with an end of the bobbin 21 on the upper side.

The guiding tube 60 has a substantially tubular shape surrounding the movable piece 70. For example, the guiding tube 60 has a substantially cylindrical shape centering on the center axis J and opening to the upper side. The guiding tube 60 supports the movable piece 70 in a manner of being able to move in the axial direction. For example, the guiding tube 60 is made of a non-magnetic material. For example, the guiding tube 60 is made of metal which is a non-magnetic material. The guiding tube 60 has a bottom 61 located on the lower side. The bottom 61 has a substantially plate shape whose plate surface is directed in the axial direction. The bottom 61 has a penetration hole 61a penetrating the bottom 61 in the axial direction. For example, the penetration hole 61a has a substantially circular shape centering on the center axis

J.

The movable piece 70 is able to move in the axial direction. The movable piece 70 has a movable piece main body 71 and the valve body 72. The movable piece main body 71 is made of a magnetic material. The movable piece main body 71 extends in the axial direction. For example, the movable piece main body 71 has a substantially columnar shape centering on the center axis J. The movable piece main body 71 has a large diameter part 71a and a small diameter part 71b.

In this exemplary embodiment, the large diameter part 71a is an upper portion of the movable piece main body 71. The large diameter part 71a is fitted into an inward side of the guiding tube 60 in the radial direction. The large diameter part 71a is supported by the guiding tube 60 in a manner of being able to move in the axial direction. A dimension of the large diameter part 71a in the axial direction is smaller than a dimension of the guiding tube 60 in the axial direction. An outer edge of the large diameter part 71a in the radial direction is provided in a manner of facing an upper side of the bottom 61 with a gap therebetween.

The large diameter part 71a has a holding recess 71c recessed from an end surface of the large diameter part 71a on the upper side to the lower side. For example, the holding recess 71c has a substantially circular shape centering on the center axis J when viewed in the axial direction. The holding recess 71c faces the holding recess 51a provided in the core 50 in the axial direction. Insides of the holding recesses 51a and 71c are portions inside the electromagnetic valve 20 where the elastic member 80 is provided. The end surface of the large diameter part 71a on the upper side is an end surface of the movable piece main body 71 on the upper side. The end surface of the movable piece main body 71 on the upper side faces an end surface of the core 50 on the lower side in the axial direction. In this exemplary embodiment, the end surface of the core 50 on the lower side is an end surface of the core main body 51 on the lower side.

In this exemplary embodiment, the small diameter part 71b is a lower portion of the movable piece main body 71. The small diameter part 71b extends from an end of the large diameter part 71a on the lower side to the lower side. An outer diameter of the small diameter part 71b is smaller than an outer diameter of the large diameter part 71a. The small diameter part 71b passes through the penetration hole 61a in the axial direction. The small diameter part 71b is fitted into the inside of the penetration hole 61a. A lower portion of the small diameter part 71b is inserted into the valve chamber 11 via the penetration hole 61a.

The movable piece main body 71 has a vent hole 73. Accordingly, the movable piece 70 has the vent hole 73. The vent hole 73 has an axial extension 73a and radial extensions 73b. The axial extension 73a extends in the axial direction from a bottom surface of the holding recess 71c to an end surface of the small diameter part 71b on the lower side. The bottom surface of the holding recess 71c is a surface of an inner surface of the holding recess 71c located on the lower side. In a cross-section orthogonal to the axial direction in which the axial extension 73a extends, for example, the axial extension 73a has a substantially circular cross-sectional shape centering on the center axis J.

An end of the axial extension 73a on the upper side is an inner opening 73c. Accordingly, the vent hole 73 has the inner opening 73c. The inner opening 73c opens to the upper side and opens to the inside of the holding recess 71c. In other words, the inner opening 73c opens to a portion inside the electromagnetic valve 20 where the elastic member 80 is provided. The vent hole 73 is connected to the inside of the electromagnetic valve 20 via the inner opening 73c.

In this exemplary embodiment, the radial extensions 73b are provided in the small diameter part 71b. More specifically, the radial extensions 73b are provided in an upper portion of the small diameter part 71b. The radial extensions 73b extend in the radial direction from an inner circumferential surface of the axial extension 73a to an outer circumferential surface of the small diameter part 71b. In a cross section orthogonal to the radial direction in which the radial extensions 73b extend, for example, the radial extensions 73b have a substantially circular cross-sectional shape. For example, a pair of radial extensions 73b are provided with the center axis J interposed therebetween.

An end of the radially extending part 73b on a side outward in the radial direction is an outer opening 73d. Accordingly, the vent hole 73 has the outer openings 73d. The outer opening 73d opens to a side outward in the radial direction. As illustrated in FIG. 2, the outer opening 73d opens to the inside of the valve chamber 11 in a state in which the valve body 72 is seated in a valve seat 34 which will be described below. A state in which the valve body 72 is seated in the valve seat 34 is a closed state CS, which will be described below. In this exemplary embodiment, in the closed state CS, a portion of the outer opening 73d excluding an end on the upper side opens to the inside of the valve chamber 11. Meanwhile, as illustrated in

FIG. 1, the entire outer opening 73d is accommodated inside the guiding tube 60 in a state in which the valve body 72 is farthest from the valve seat 34. A state in which the valve body 72 is farthest from the valve seat 34 is a state in which the movable piece 70 provided in a manner of being able to move in the axial direction is located on the uppermost side and is an open state OS, which will be described below.

The valve body 72 is fixed to an end of the movable piece main body 71 on the lower side. More specifically, the valve body 72 is fixed to an end of the small diameter part 71b on the lower side. As illustrated in FIG. 2, the valve body 72 is able to be seated in the valve seat 34 (which will be described below) from the upper side. In this exemplary embodiment, the valve body 72 is made of rubber. For example, the valve body 72 has a substantially columnar shape centering on the center axis J. The valve body 72 has a valve body main body 72a and a protrusion 72b.

The valve body main body 72a is located on a lower side of the movable piece main body 71. The valve body main body 72a comes into contact with an end surface of the movable piece main body 71 on the lower side. An outer circumferential surface at an end of the valve body main body 72a on the lower side is a tapered surface 72c whose outer diameter is reduced toward the lower side. The protrusion 72b protrudes upward from the valve body main body 72a. For example, the protrusion 72b has a substantially columnar shape centering on the center axis J. An outer diameter of the protrusion 72b is smaller than an outer diameter of the valve body main body 72a. The protrusion 72b is fixed by being fitted to an end of the axial extension 73a on the lower side from the lower side. For example, the protrusion 72b is press-fitted into the end of the axial extension 73a on the lower side. The end of the axial extension 73a on the lower side is blocked by the valve body 72.

For example, the elastic member 80 is a coil spring extending in the axial direction. The elastic member 80 is provided inside the electromagnetic valve 20. In this exemplary embodiment, the elastic member 80 is provided in a manner of straddling the inside of the holding recess 51a and the inside of the holding recess 71c. An end of the elastic member 80 on the lower side comes into contact with the bottom surface of the holding recess 71c. An end of the elastic member 80 on the upper side comes into contact with a bottom surface of the holding recess 51a. The bottom surface of the holding recess 51a is a surface of an inner surface of the holding recess 51a located on the upper side. The elastic member 80 applies an elastic force to the movable piece 70 in the axial direction. In this exemplary embodiment, the elastic member 80 applies an elastic force directed to the lower side to the movable piece 70.

The accommodation case 90 has a substantially tubular shape surrounding the center axis J. For example, the accommodation case 90 has a substantially cylindrical shape centering on the center axis J and opening to both sides in the axial direction. The accommodation case 90 internally accommodates the bobbin 21, the coil 22, the resin member 23, the annular member 40, the core 50, an upper portion of the guiding tube 60, an upper portion of the movable piece 70, and the elastic member 80. The accommodation case 90 is made of a magnetic material.

An end of the accommodation case 90 on the lower side is caulked on the inward side in the radial direction and comes into contact with the flange 14 from the lower side. An end of the accommodation case 90 on the upper side is caulked on the inward side in the radial direction and comes into contact with the core flange 52 from the upper side. The flange 14, the annular member 40, the bobbin 21, and the core flange 52 are sandwiched in the axial direction and are fixed to each other by the caulked portions of the accommodation case 90 on both sides in the axial direction. Accordingly, the electromagnetic valve 20 is attached to the flow channel member 10.

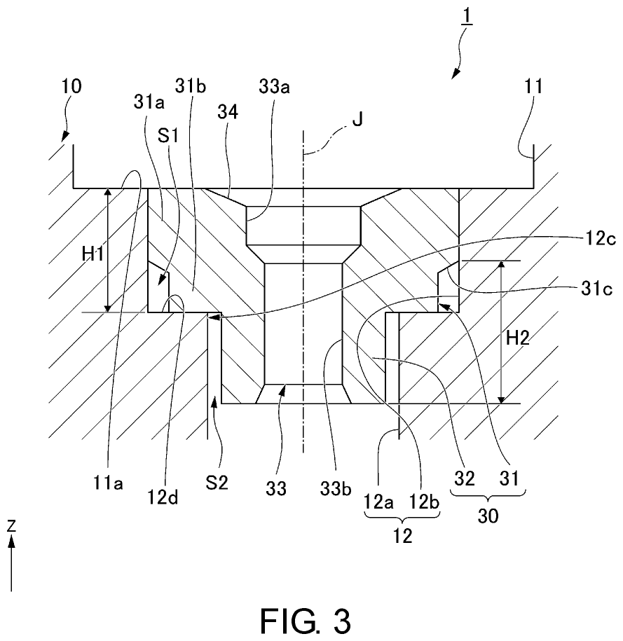

In this exemplary embodiment, the valve seat body 30 is made of metal. A metal material constituting the valve seat body 30 is not particularly limited. For example, a material constituting the valve seat body 30 is a material of stainless steel subjected to nitriding. The valve seat body 30 is fixed to the first flow channel 12. More specifically, the valve seat body 30 is fixed to the opening 12b of the first flow channel 12. The valve seat body 30 is an annular member opening to both sides in the axial direction. For example, the valve seat body 30 has a substantially circular annular shape centering on the center axis J. As illustrated in FIG. 3, the valve seat body 30 has a fixed part 31 and an extension 32.

The fixed part 31 is an upper portion of the valve seat body 30. The fixed part 31 is fixed by being fitted into the inside of the opening 12b. For example, the fixed part 31 is press-fitted into the opening 12b. For example, the fixed part 31 has a substantially circular annular shape centering on the center axis J. The fixed part 31 has a contact part 31a, a reduced diameter part 31b, and a boundary 31c.

The contact part 31a is a portion where the outer circumferential surface comes into contact with the inner circumferential surface of the opening 12b. For example, the contact part 31a is press-fitted into the opening 12b. In this exemplary embodiment, the contact part 31a is an upper portion of the fixed part 31.

The reduced diameter part 31b is located below the contact part 31a. In this exemplary embodiment, the reduced diameter part 31b is connected to a lower side of the contact part 31a with the boundary 31c therebetween. In this exemplary embodiment, the reduced diameter part 31b is a lower portion of the fixed part 31. An outer diameter of the reduced diameter part 31b is smaller than an outer diameter of the contact part 31a. An end of the reduced diameter part 31b on the lower side comes into contact with the step surface 12d. Accordingly, the fixed part 31 is supported by the step 12c from the lower side. A gap S1 is defined between an outer circumferential surface of the reduced diameter part 31b and the inner circumferential surface of the opening 12b. For example, the gap S1 is a gap having a substantially circular annular shape centering on the center axis J. For example, a dimension of the reduced diameter part 31b in the axial direction is smaller than a dimension of the contact part 31a in the axial direction.

The boundary 31c is a portion connecting the contact part 31a and the reduced diameter part 31b to each other in the axial direction. The boundary 31c has an outer diameter reduced toward the reduced diameter part 31b from the contact part 31a. An outer circumferential surface of the boundary 31c is a tapered surface whose outer diameter is reduced toward the lower side from the upper side.

The extension 32 extends downward from the fixed part 31. For example, the extension 32 has a substantially cylindrical shape centering on the center axis J. The extension 32 is inserted into the first flow channel main body 12a. A gap S2 is defined between an outer circumferential surface of the extension 32 and the inner circumferential surface of the first flow channel main body 12a. For example, the gap S2 is a gap having a substantially circular annular shape centering on the center axis J. The gap S2 opens to the lower side. The gap S2 between the outer circumferential surface of the extension 32 and the inner circumferential surface of the first flow channel main body 12a is smaller than the gap S1 between the outer circumferential surface of the reduced diameter part 31b and the inner circumferential surface of the opening 12b.

For example, a dimension of the extension 32 in the axial direction is smaller than a dimension of the fixed part 31 in the axial direction. A distance H2 from an end of the extension 32 on the lower side to an end of the contact part 31a on the lower side in the axial direction is longer than a dimension H1 of the opening 12b in the axial direction. For example, the dimension H1 of the opening 12b in the axial direction is equal to the dimension of the fixed part 31 in the axial direction.

The valve seat body 30 has a circulation hole 33 penetrating the fixed part 31 and the extension 32 in the axial direction. Since the circulation hole 33 is provided, the valve seat body 30 has a substantially annular shape opening to both sides in the axial direction. In other words, the inside of the substantially annular valve seat body 30 is the inside of the circulation hole 33. For example, the circulation hole 33 is a hole having a substantially circular shape centering on the center axis J. The circulation hole 33 has a first circulator 33a and a second circulator 33b.

The first circulator 33a is an upper portion of the circulation hole 33. An end of the first circulator 33a on the upper side is an end of the circulation hole 33 on the upper side. The first circulator 33a opens to the upper side. The first circulator 33a opens to the inside of the valve chamber 11. In this exemplary embodiment, the first circulator 33a is provided in the fixed part 31. More specifically, the first circulator 33a is provided in a manner of straddling the contact part 31a and the boundary 31c in the fixed part 31. For example, an end of the first circulator 33a on the lower side is located at the same position as an end of the boundary 31c on the lower side in the axial direction.

The valve seat 34 is provided at the end of the first circulator 33a on the upper side.

Accordingly, the circulation hole 33 has the valve seat 34 provided at the end of the circulation hole 33 on the upper side. For example, the valve seat 34 is provided to have a chamfered edge at the end of the first circulator 33a on the upper side. An inner circumferential surface of the valve seat 34 is directed obliquely upward to the inward side in the radial direction. For example, the inner circumferential surface of the valve seat 34 is a tapered surface whose inner diameter increases toward the upper side. In this exemplary embodiment, the valve seat 34 is provided in the fixed part 31.

In this exemplary embodiment, the second circulator 33b is connected to a lower side of the first circulator 33a. The second circulator 33b opens to the lower side. The second circulator 33b opens to the inside of the first flow channel main body 12a. An inner diameter of the second circulator 33b is smaller than an inner diameter of the first circulator 33a. In other words, the inner diameter of the first circulator 33a is larger than the inner diameter of the second circulator 33b. In this exemplary embodiment, the inner diameter of the second circulator 33b is the smallest inner diameter in the circulation hole 33. A cross-sectional area of the flow channel of the second circulator 33b is smaller than a cross-sectional area of the flow channel of the first circulator 33a. For example, a dimension of the second circulator 33b in the axial direction is larger than a dimension of the first circulator 33a in the axial direction.

At least a portion of the second circulator 33b is provided in the extension 32. In this exemplary embodiment, the second circulator 33b is provided in a manner of straddling the fixed part 31 and the extension 32. More specifically, the second circulator 33b is provided in a manner of straddling the reduced diameter part 31b of the fixed part 31 and the extension 32. For example, an end of the second circulator 33b on the upper side is located at the same position as an end of the reduced diameter part 31b on the upper side in the axial direction.

The valve device 1 of this exemplary embodiment switches between the open state OS in which the first flow channel 12 is open and the closed state CS in which the first flow channel 12 is closed by the electromagnetic valve 20. FIG. 1 illustrates the open state OS, and FIG. 2 illustrates the closed state CS.

When no electricity is supplied to the electromagnetic valve 20, the valve device 1 is in the closed state CS illustrated in FIG. 2. In the closed state CS, the movable piece 70 is pushed downward by the elastic member 80, and the valve body 72 is pressed to the valve seat 34. Accordingly, the valve body 72 is seated in the valve seat 34, and the circulation hole 33 is blocked by the valve body 72. Therefore, the first flow channel 12 is closed, and thus inflow of the gas G from the first flow channel 12 to the inside of the valve chamber 11 is inhibited. In the closed state CS in which no electricity is supplied to the electromagnetic valve 20, an upper end surface of the movable piece 70 is located on the lower side away from a lower end surface of the core 50. In this exemplary embodiment, the upper end surface of the movable piece 70 is the upper end surface of the movable piece main body 71.

Meanwhile, when electricity is supplied to the electromagnetic valve 20, the valve device 1 is in the open state OS illustrated in FIG. 1. If electricity is supplied to the electromagnetic valve 20, a current flows to the coil 22, and a magnetic field in which a magnetic flux flows in the axial direction is generated on the inward side of the coil 22 in the radial direction. Accordingly, a magnetic circuit passing through each of the parts made of a magnetic material in the electromagnetic valve 20 is provided.

Specifically, for example, when a magnetic flux caused by a magnetic field of the coil 22 flows from the lower side to the upper side on the inward side of the coil 22 in the radial direction, a magnetic circuit in which a magnetic flux passes through the core main body 51, the core flange 52, the accommodation case 90, and the annular member 40 in this order from the large diameter part 71a of the movable piece main body 71 and returns to the large diameter part 71a of the movable piece main body 71 is provided. Accordingly, each of the parts made of a magnetic material is excited, and a magnetic force attracting the movable piece main body 71 and the core 50 to each other is generated therebetween. Therefore, a magnetic force generated between the movable piece main body 71 and the core 50 is made greater than the elastic force of the elastic member 80 by supplying sufficient electricity to the electromagnetic valve 20, and thus the movable piece 70 is able to be moved upward against the elastic force of the elastic member 80. Accordingly, the valve body 72 is separated from the valve seat 34 to the upper side, and the circulation hole 33 opens to the inside of the valve chamber 11. Therefore, the first flow channel 12 is opened, and thus inflow of the gas G from the first flow channel 12 to the inside of the valve chamber 11 is allowed. The gas G that has flowed into the valve chamber 11 flows out from the second flow channel 13.

In the open state OS in which electricity is supplied to the electromagnetic valve 20, the upper end surface of the movable piece 70 comes into contact with the lower end surface of the core 50. In this state, the upper end surface of the movable piece main body 71 and the lower end surface of the core 50 are in a stuck state due to a magnetic force.

If supply of electricity to the electromagnetic valve 20 is stopped, a magnetic circuit vanishes, and a magnetic force between the movable piece main body 71 and the core 50 vanishes. Therefore, the movable piece 70 moves downward due to the elastic force of the elastic member 80. Accordingly, the valve body 72 is seated in the valve seat 34, and the first flow channel 12 is closed.

As described above, in this exemplary embodiment, the movable piece 70 is able to be moved in the axial direction by switching ON/OFF of electricity supplied to the electromagnetic valve 20, and the first flow channel 12 is able to be opened and closed in accordance with movement of the movable piece 70. In this manner, the electromagnetic valve 20 is able to open and close the first flow channel 12.

A magnetic field generated by the coil 22 may be a magnetic field in which a magnetic flux flows from the upper side to the lower side on the inward side of the coil 22 in the radial direction. In this case, a magnetic circuit in which a magnetic flux passes through the large diameter part 71a of the movable piece main body 71, the annular member 40, the accommodation case 90, and the core flange 52 in this order from the core main body 51 and returns to the core main body 51 is provided. Even in such a magnetic circuit, the movable piece 70 is able to be moved upward due to a magnetic force by exciting each of the parts made of a magnetic material.

According to this exemplary embodiment, the inner diameter of the first circulator 33a provided with the valve seat 34 is larger than the inner diameter of the second circulator 33b. Therefore, an inner diameter of the valve seat 34 is able to be made relatively large. Accordingly, the valve body 72 is able to be stably seated in the valve seat 34. Therefore, the valve body 72 is able to be suitably seated in the valve seat 34, and thus sealing properties between the valve body 72 and the valve seat 34 are able to be improved. Therefore, in the closed state CS in which the valve body 72 is seated in the valve seat 34, the first flow channel 12 is able to be suitably closed. Accordingly, in the closed state CS, leakage of the gas G to the inside of the valve chamber 11 is able to be curbed.

In addition, the inner diameter of the second circulator 33b is smaller than the inner diameter of the first circulator 33a. Therefore, regardless of the inner diameter of the first circulator 33a, a flow rate of the gas G passing through the circulation hole 33 becomes equal to or lower than the flow rate of the gas G which is able to pass through the second circulator 33b. Accordingly, even if the inner diameter of the first circulator 33a is increased, excessive increase of the flow rate of the gas G passing through the circulation hole 33 is able to be curbed. Therefore, sealing properties between the valve body 72 and the valve seat 34 are able to be improved, and the flow rate of the gas G flowing into the valve chamber 11 in the open state OS is able to be suitably adjusted. Therefore, the flow rate of the gas G flowing from the first flow channel 12 to the second flow channel 13 via the valve chamber 11 is able to be suitably adjusted.

In this exemplary embodiment, since the inner diameter of the second circulator 33b is the smallest inner diameter in the circulation hole 33, the flow rate of the gas G passing through the circulation hole 33 is determined based on the inner diameter of the second circulator 33b. Therefore, the flow rate of the gas G flowing into the valve chamber 11 in the open state OS is able to be suitably adjusted by adjusting the inner diameter of the second circulator 33b.

In addition, at least a portion of the second circulator 33b is provided in the extension 32. Therefore, the dimension of the second circulator 33b in the axial direction is able to be easily made relatively large. Accordingly, a flow of the gas G flowing inside the second circulator 33b is easily made stable. Therefore, a flow of the gas G flowing into the valve chamber 11 from the circulation hole 33 is able to be made stable, and the flow rate of the gas G flowing into the valve chamber 11 is easily made stable. Therefore, the flow rate of the gas G flowing from the first flow channel 12 to the second flow channel 13 via the valve chamber 11 is able to be more suitably adjusted.

In addition, since the valve seat body 30 is a body separate from the flow channel member 10, a material constituting the valve seat body 30 and a material constituting the flow channel member 10 are able to be different materials. Accordingly, for example, the weight of the valve device 1 is able to be reduced and abrasion of the valve seat 34 is able to be curbed by constituting the flow channel member 10 of a material having a relatively light weight and constituting the valve seat body 30 of a material having a relatively high strength.

Specifically, according to this exemplary embodiment, the valve seat body 30 is made of metal. Therefore, the valve seat 34 is able to have a relatively high strength. Accordingly, even if the valve body 72 comes into contact with and is separated from the valve seat 34 repeatedly, abrasion of the valve seat 34 is able to be curbed. In addition, for example, when the flow channel member 10 is made of resin, compared with a case in which the flow channel member 10 is made of metal, the weight of the flow channel member 10 is able to be reduced. Accordingly, the weight of the valve device 1 is able to be reduced.

In addition, according to this exemplary embodiment, the movable piece 70 has the vent hole 73 connected to the inside of the electromagnetic valve 20. Therefore, the weight of the movable piece 70 is able to be reduced by the amount of the vent hole 73 provided therein. In addition, according to this exemplary embodiment, the vent hole 73 has the outer opening 73d opening to the inside of the valve chamber 11 in a state in which the valve body 72 is seated in the valve seat 34. Therefore, when the movable piece 70 moves in the axial direction, the inside of the electromagnetic valve 20 and the inside of the valve chamber 11 are connected to each other via the vent hole 73. Accordingly, when the movable piece 70 moves in the axial direction, air is able to flow between the inside of the electromagnetic valve 20 and the inside of the valve chamber 11. Therefore, the movable piece 70 is able to be easily moved in the axial direction.

Specifically, for example, when the movable piece 70 moves downward and the valve device 1 is switched from the open state OS to the closed state CS, air inside the valve chamber 11 is suctioned to a space between the movable piece 70 and the core 50 via the vent hole 73. Accordingly, a situation in which an internal pressure of the electromagnetic valve 20 becomes negative is able to be curbed, and the movable piece 70 is able to be easily moved to the lower side. In addition, for example, when the movable piece 70 moves upward and the valve device 1 is switched from the closed state CS to the open state OS, air between the movable piece 70 and the core 50 is discharged to the inside of the valve chamber 11 via the vent hole 73. Accordingly, the movable piece 70 is able to be easily moved upward.

In addition, according to this exemplary embodiment, the entire outer opening 73d is accommodated inside the guiding tube 60 in a state in which the valve body 72 is farthest from the valve seat 34. Therefore, the outer opening 73d is able to be accommodated inside the guiding tube 60 in the open state OS. Accordingly, in the open state OS, inflow of the gas G, which has flowed into the valve chamber 11 from the circulation hole 33, from the outer opening 73d to the vent hole 73 is able to be curbed. Therefore, infiltration of the gas G into the electromagnetic valve 20 via the vent hole 73 is able to be curbed. Therefore, leakage of the gas G to outside of the valve device 1 via the inside of the electromagnetic valve 20 is able to be curbed.

In addition, according to this exemplary embodiment, the elastic member 80 applying an elastic force to the movable piece 70 in the axial direction is provided inside the electromagnetic valve 20. The vent hole 73 has the inner opening 73c opening to a portion inside the electromagnetic valve 20 where the elastic member 80 is provided. Here, as described above, since the outer opening 73d is accommodated inside the guiding tube 60 in the open state OS, inflow of the gas G to the vent hole 73 is curbed. Accordingly, in the open state

OS, inflow of the gas G from the inner opening 73c to a portion accommodating the elastic member 80 is also curbed. Therefore, for example, deterioration of the elastic member 80, such as corrosion of the elastic member 80 due to the gas G, is able to be curbed.

In addition, according to this exemplary embodiment, the valve body 72 is made of rubber. Therefore, compared with a case in which the valve body 72 is made of metal, noise generated when the valve body 72 is seated in the valve seat 34 is able to be curbed. In addition, compared with a case in which the valve body 72 is made of metal, the valve seat 34 with which the valve body 72 comes into contact is able to be made unlikely to be abraded. In addition, compared with a case in which the valve body 72 is made of metal, the valve body 72 is easily brought into tight contact with the valve seat 34. Therefore, sealing properties between the valve body 72 and the valve seat 34 are able to be further improved.

In addition, according to this exemplary embodiment, the distance H2 from the end of the extension 32 on the lower side to the end of the contact part 31a on the lower side in the axial direction is longer than the dimension H1 of the opening 12b in the axial direction. Therefore, when the valve seat body 30 is fixed to the opening 12b in a manner of approaching from the upper side, the extension 32 is able to be inserted into the first flow channel main body 12a before the contact part 31a is fitted into the opening 12b. Accordingly, in a state in which the extension 32 is inserted into the first flow channel main body 12a and a position of the valve seat body 30 in the radial direction is subjected to positioning to a certain degree, the contact part 31a is able to be fitted into the opening 12b. Therefore, the valve seat body 30 is able to be easily fixed to the opening 12b. Particularly, in this exemplary embodiment, the contact part 31a is able to be press-fitted into the opening 12b.

In addition, since the valve seat body 30 is able to be press-fitted into the inside of the opening 12b in a state in which the extension 32 is inserted into the first flow channel main body 12a, inclination of the valve seat body 30 at the time of being press-fitted is able to be curbed. Accordingly, the valve seat body 30 is able to be accurately fixed to the first flow channel 12. Therefore, accuracy of disposition of the valve seat 34 provided in the valve seat body 30 is able to be improved. Therefore, the valve body 72 is able to be suitably seated in the valve seat 34. Accordingly, sealing properties between the valve body 72 and the valve seat 34 are able to be further improved.

In addition, the reduced diameter part 31b having a smaller outer diameter than the contact part 31a is located below the contact part 31a. Therefore, the distance H2 from the end of the extension 32 on the lower side to the end of the contact part 31a on the lower side in the axial direction is able to be increased by the amount of the reduced diameter part 31b provided in the fixed part 31. Accordingly, even if the dimension of the extension 32 in the axial direction is made smaller than the dimension H1 of the opening 12b in the axial direction, the distance H2 is able to be made longer than the dimension H1. Therefore, the dimension of the extension 32 in the axial direction is able to be reduced, and the valve seat body 30 is able to be easily fixed via the extension 32.

In addition, according to this exemplary embodiment, the gap S2 between the outer circumferential surface of the extension 32 and the inner circumferential surface of the first flow channel main body 12a is smaller than the gap S1 between the outer circumferential surface of the reduced diameter part 31b and the inner circumferential surface of the opening 12b. Therefore, if a position of the valve seat body 30 in the radial direction is subjected to positioning at a position where the extension 32 is able to be inserted into the first flow channel main body 12a, the reduced diameter part 31b is also able to be inserted into the opening 12b. Namely, as long as positioning is performed by using the extension 32, the reduced diameter part 31b does not interfere with a circumferential edge of the opening 12b. Accordingly, the reduced diameter part 31b is able to be easily inserted into the opening 12b. Therefore, the valve seat body 30 is able to be more easily fixed to the opening 12b.

In addition, suppose that the dimension of the extension 32 in the axial direction is larger than the dimension of the opening 12b in the axial direction, as long as the extension 32 is inserted into the first flow channel main body 12a, even if the extension 32 moves in the radial direction inside the first flow channel main body 12a, the reduced diameter part 31b does not deviate outward in the radial direction beyond the opening 12b. Therefore, after the extension 32 is inserted into the first flow channel main body 12a, the reduced diameter part 31b is able to be easily inserted into the opening 12b. Accordingly, the valve seat body 30 is able to be more easily fixed to the opening 12b.

In addition, the gap S2 between the outer circumferential surface of the extension 32 and the inner circumferential surface of the first flow channel main body 12a is able to be made relatively small. Therefore, the gas G is able to be made unlikely to enter the gap S2 inside the first flow channel main body 12a. Accordingly, arrival of the gas G at a boundary between the step surface 12d facing the inside of the gap S2 and a lower surface of the fixed part 31 is able to be curbed. Therefore, leakage of the gas G to the valve chamber 11 via a space between the step surface 12d and the lower surface of the fixed part 31 is able to be suitably curbed.

The disclosure is not limited to the embodiment described above, and other constitutions and other methods are also able to be employed within the scope of the technical idea of the disclosure. A material constituting a flow channel member is not particularly limited. A material constituting a flow channel member may be metal. The flow channel member may have any shape as long as it has a first flow channel. A fluid flowing in the first flow channel and the second flow channel is not particularly limited, and it may be gas other than blow-by gas or may be liquid. The first flow channel to which a valve seat body is fixed may be an outlet port through which a fluid flows out. The flow channel member may not have a valve chamber. The flow channel member may not have a second flow channel.

A material constituting a valve seat body is not particularly limited. A material constituting a valve seat body may be a material other than metal having a hardness higher than a material constituting a flow channel member. The valve seat body may be made of hard rubber. A fixed part may not have a reduced diameter part. A distance in the predetermined direction from an end of an extension on the other side in the predetermined direction to an end of a contact part on the other side in the predetermined direction may be equal to or shorter than a dimension of an opening in the predetermined direction. A gap between an outer circumferential surface of the extension and an inner circumferential surface of a first flow channel main body may have the same size as a gap between the outer circumferential surface of the reduced diameter part and the inner circumferential surface of the opening or may be larger than the gap between the outer circumferential surface of the reduced diameter part and the inner circumferential surface of the opening. For example, the valve seat body may be fixed to the first flow channel with an adhesive therebetween.

A circulation hole may have a third circulator having an inner diameter smaller than an inner diameter of a second circulator. In this case, for example, a flow rate of a fluid flowing into the valve chamber is able to be adjusted by adjusting the inner diameter of the third circulator.

An electromagnetic valve may have any structure as long as it has a movable piece capable of moving in the predetermined direction. In the exemplary embodiment described above, the electromagnetic valve has a structure in which the first flow channel is open when electricity is supplied and the first flow channel is closed when no electricity is supplied, but the structure is not limited thereto. The electromagnetic valve may have a structure in which the first flow channel is closed when electricity is supplied and the first flow channel is opened when no electricity is supplied. In addition, the electromagnetic valve may be a self-holding-type electromagnetic valve capable of holding the open/closed state of the first flow channel in each of the open state and the closed state even if electricity is not continuously supplied. A material constituting a valve body of the movable piece is not particularly limited. The valve body may be made of metal. The movable piece may not have a vent hole.

The purpose of the valve device to which the disclosure is applied is not particularly limited. For example, the valve device may be mounted in equipment in addition to a vehicle.

Features of the above-described preferred embodiments and the modifications thereof may be combined appropriately as long as no conflict arises.

While preferred embodiments of the present disclosure have been described above, it is to be understood that variations and modifications will be apparent to those skilled in the art without departing from the scope and spirit of the present disclosure. The scope of the present disclosure, therefore, is to be determined solely by the following claims.

What is claimed is:

1. A valve device comprising:
a flow channel member that has a first flow channel;
an electromagnetic valve that has a movable piece capable of moving in a predetermined direction and is capable of opening and closing the first flow channel; and
a valve seat body that is fixed to the first flow channel,
wherein the first flow channel has:
a first flow channel main body; and
an opening which has an inner diameter larger than an inner diameter of the first flow channel main body and is connected to one end of the first flow channel main body with a step therebetween,
wherein the opening opens to one side in the predetermined direction,
wherein the valve seat body has:
a fixed part which is fixed by being fitted into an inside of the opening and is supported by the step from the other side in the predetermined direction;
an extension which extends from the fixed part to the other side in the predetermined direction and is inserted into the first flow channel main body;
a circulation hole which penetrates the fixed part and the extension in the predetermined direction; and
a valve seat which is provided at an end of the circulation hole on the one side in the predetermined direction,
wherein the movable piece has a valve body which is able to be seated in the valve seat from the one side in the predetermined direction,
wherein the circulation hole has:
a first circulator which opens to the one side in the predetermined direction and is provided in the valve seat; and
a second circulator at least a portion of which is provided in the extension, and
wherein an inner diameter of the first circulator is larger than an inner diameter of the second circulator.

2. The valve device according to claim 1, wherein the valve seat body is made of metal.

3. The valve device according to claim 1, wherein the electromagnetic valve has a guiding tube in a tubular shape which surrounds the movable piece,
wherein the guiding tube supports the movable piece in a manner of being able to move in the predetermined direction,
wherein the flow channel member has:
a valve chamber into which the valve body is inserted; and
a second flow channel which is connected to the valve chamber,
wherein the first flow channel is a flow channel which is connected to the valve chamber via the opening and through which a fluid flowing into the valve chamber passes,
wherein the second flow channel is a flow channel through which a fluid that has flowed into the valve chamber via the first flow channel flows out,
wherein the movable piece has a vent hole which is connected to an inside of the electromagnetic valve,
wherein the vent hole has an outer opening which opens to an inside of the valve chamber in a state in which the valve body is seated in the valve seat, and
wherein the entire outer opening is accommodated inside the guiding tube in a state in which the valve body is farthest from the valve seat.

4. The valve device according to claim 3, wherein the electromagnetic valve has an elastic member which applies an elastic force to the movable piece in the predetermined direction,
wherein the elastic member is provided inside the electromagnetic valve, and
wherein the vent hole has an inner opening which opens to a portion inside the electromagnetic valve where the elastic member is provided.

5. The valve device according to claim 1, wherein the valve body is made of rubber.

6. The valve device according to claim 1, wherein the fixed part has a contact part where an outer circumferential surface comes into contact with an inner circumferential surface of the opening, and
wherein a distance in the predetermined direction from an end of the extension on the other side in the predetermined direction to an end of the contact part on the other side in the predetermined direction is longer than a dimension of the opening in the predetermined direction.

7. The valve device according to claim 6, wherein the fixed part has a reduced diameter part having an outer diameter smaller than an outer diameter of the contact part, and
wherein the reduced diameter part is located closer to the other side in the predetermined direction than the contact part.

8. The valve device according to claim 7, wherein a gap between an outer circumferential surface of the extension and an inner circumferential surface of the first flow channel main body is smaller than a gap between an outer circumferential surface of the reduced diameter part and the inner circumferential surface of the opening.
